(19) United States
(12) Patent Application Publication
(10) Pub. No.: US 2008/0126097 A1
(43) Pub. Date: May 29, 2008

(54) VOICE CONFIRMATION AUTHENTICATION FOR DOMAIN NAME TRANSACTIONS

(75) Inventors: Sahar Sarid, Pompano Beach, FL (US); Kishore Bhavnanie, Bethlehem, PA (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Ashantiplc Limited, Hong Kong (CN)

(21) Appl. No.: 11/563,497

(22) Filed: Nov. 27, 2006

(51) Int. Cl. G10L 11/00; G10L 13/08; G10L 21/00

(52) U.S. Cl. 704/270.1; 704/273; 704/260; 704/E15.044; 704/E17.003; 379/88.02

(57) ABSTRACT

A method with an information processing system manages a user transaction request associated with a domain name based on an authentication status of a user. The method comprises receiving a request from a user for a transaction associated with a domain name. A voice confirmation user interface is presented to the user and user authentication information, such as spoken user authentication information from the user, is collected. The user authentication information is communicated to an information processing system. An authentication status associated with the user is received from the information processing system. The method also includes determining to allow the request from the user for the transaction associated with the domain name based at least in part on the received authentication status.

### FIELD OF THE INVENTION

The present invention generally relates to the field of management of domain names, and more particularly relates to authenticating domain name transactions.

### BACKGROUND OF THE INVENTION

Domain name registration allows for a user to select and register a unique domain name with a domain name registrar. Domain name registrars, which are controlled by a registry, provide the registration services to users and also are accredited by the Internet Corporation for Assigned Names and Numbers to sell domain names. In other words, a registrar dispenses domain names to a registrant. When a domain name is registered with a domain name registry, information associated with the domain name is entered into a database called a domain name registry. For example, the IP address mapped to the domain name in the domain name system on the Internet is entered into the domain name registry The information associated with a domain name such as registrant contact information, administration information, and the like can be queried using a WHOIS client, which is a TCP base query/response protocol.

Generally, the registration process and other transactions such as contact information updates, change of ownership, and the like for a domain name occurs over the Internet via a website and e-mail. Although this method may be efficient, it does not offer much security. For example, identity verification for authenticating such transactions is currently performed by transmitting an e-mail message to the party requesting the transaction. Usually this verification e-mail is sent to the e-mail that is associated with the domain name during the registration process or the e-mail associated with the transaction request is matched to the e-mail on file. For example, for domain name transfers, an email to acknowledge the transfer is sent from the gaining registrar to the administration contact email on the WHOIS database. Once the email is confirmed by the administration, the gaining registrar sends a notice to the registry to transfer the domain name to the gaining registrar.

Another method of transferring domain names form one registrar to another registrar is as follows. Each registrar is given an authentication code by the registry (or created by random). A registrant uses the code provided by the loosing registrar during a transfer initiation on the gaining registrar's website. The gaining registrar sends the code and the domain name to the registry which matches the code against its database to authenticate the transaction and acknowledges the transfer.

Verifying by e-mail does not offer a high level of security or reliability. For example, e-mail addresses can be spoofed so that an e-mail coming from a fraudulent user looks to be coming from the rightful owner of the domain name. Also, if the registrant of the domain name changes e-mail addresses, the domain name registrar may not have the correct e-mail address on file. This situation can cause problems when an e-mail is used to verify the identity of the registrant when an associated transaction is request for the domain name.

Therefore, a need exists to overcome the problems with the prior art as discussed above.

### SUMMARY OF THE INVENTION

Briefly, in accordance with the present invention, disclosed are a methods and information processing systems for managing a user transaction request associated with a domain name based on an authentication status of the user. The method comprises receiving a request from a user for a transaction associated with a domain name. A voice confirmation user interface is presented to the user and user authentication information comprising spoken user authentication information is collected. The user authentication information is communicated to an information processing system. An authentication status associated with the user is received from the information processing system. The method also includes determining to allow the request from the user for the transaction associated with the domain name based at least in part on the received authentication status.

In another embodiment, a method for authenticating a domain name registrant is disclosed. The method includes receiving a request for authenticating a user requesting a transaction associated with a domain name. An audible communication link is established with a communication device associated with the user. The user is prompted to enter user authentication information. Spoken user authentication information is received from the user. The spoken user authentication information is received from the user analyzed. The authenticity of the user is determined based on the analyzing of the user authentication information.

In yet another embodiment of the present invention, an information processing system for authenticating a domain name registrant is disclosed. The information processing system includes a memory and a processor that is communicatively coupled to the memory. An authentication request receiver receives a request for authenticating a user requesting a transaction associated with a domain name. A telephony module establishes audible communication link with a communication device associated with the user. A voice confirmation module prompts the user to enter user authentication information over the audible communication link. The voice confirmation module also receives spoken user authentication information from the user. An authentication information analyzer analyzes the spoken user authentication information received from the user. A user authenticator determines the authenticity of the user based on the analyzing of the user authentication information.

In another embodiment, an information processing system for managing a user transaction request associated with a domain name based on an authentication status of the user. The information processing system includes a memory and a processor that is communicatively coupled to the memory. A user request receiver receives a request from a user for a transaction associated with a domain name. A voice conformation user interface is also included that is presented to the user for collecting user authentication information. A transmitter communicates the user authentication information to an information processing system. A user authentication receiver receives an authentication status associated with the user from the information processing system. The request from the user for the transaction associated with the domain name is allowed based at least in part on the received authentication status.

The present invention, according to an embodiment, overcomes problems with the prior art by providing a voice confirmation system that is used to verify the identity of a party requesting a transaction associated with a domain name. Domain name registrars can locally implement the voice confirmation system of the present invention or re-direct a registrant to a remote server hosting the voice confirmation system. A party requesting a domain name transaction is contacted by the voice confirmation system and prompted to enter a unique pin number and/or provide an audible identifier. The pin number and/or audible identifier are analyzed by the voice confirmation system and the results are then transmitted to the domain name registrar. Therefore, a more secure and reliable procedure is provided for verifying/authenticating domain name transaction requests.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a schematic diagram illustrating a network system suitable for use with a voice confirmation system according to one embodiment of the present invention;

FIG. 2 is a block diagram illustrating a voice confirmation server according to one embodiment of the present invention;

FIG. 3 is a block diagram illustrating a domain name registrar server according to one embodiment of the present invention;

FIG. 4 is a schematic diagram of an voice confirmation user interface according to one embodiment of the present invention;

FIG. 5 is an operational flow diagram illustrating the overall process of a domain name registrar server interacting with the voice confirmation server for authenticating a user according to one embodiment of the present invention; and

FIG. 6 is an operational flow diagram illustrating an overall process of authentication of a user via a voice confirmation server according to one embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Exemplary System

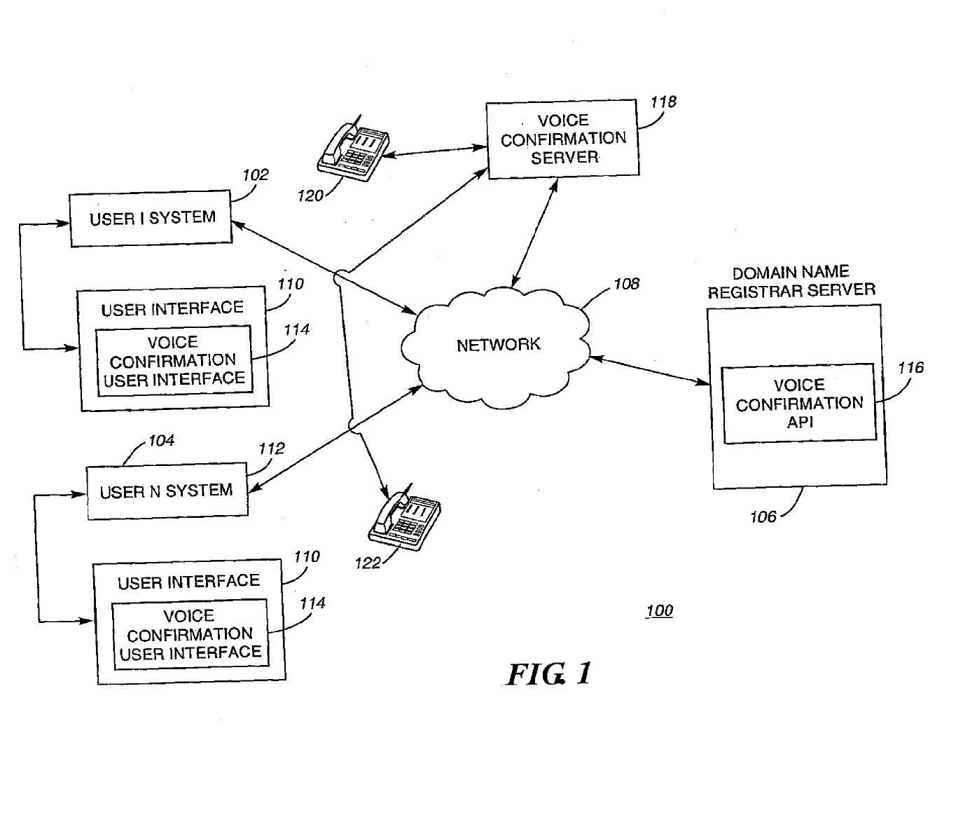

According to an embodiment of the present invention, as shown in FIG. 1, an exemplary system 100 is illustrated. FIG. 1 shows a system 100 comprising a plurality of user systems 102, 104, Each of the user systems 102, 104 communicate with a domain name registrar server 106 through a network 108. The user systems 102, 104, in one embodiment, are personal computers, notebook computers, workstations, PDAs, cellular phones capable of browsing the Internet, and the like. The network 108, according to one embodiment, comprises a LAN, WAN, World Wide Web, wireless network, or the like. The user systems 102, 104, for example, are communicating with the domain name registrar server 106 to register a domain name, update registrant information associated with a domain name, and the like.

The user systems 102, 104 are communicatively coupled to a user interface 110, 112, such as a display so that a user can interact with voice confirmation user interface 114 provided, in one embodiment, via the domain name registrar server 106. The user interface 110, 112 also allows a user to interact with a domain name registrar user interface (not shown) provided by the domain name registrar server 106. In one embodiment, the voice confirmation user interface 110, 112 appears to a user as part of the domain name registrar user interface (not shown). For example, if a user requests a transaction such as updating registrant information through the domain name registrar interface (not shown), the registrar domain server 106 presents the voice confirmation user interface 110, 112 to the user.

In one embodiment, the domain name registrar server 106 includes a voice confirmation API 116, which allows the domain name registrar to utilize the voice confirmation services of the voice confirmation server 118. For example, an integration interface such as an XML interface can be used by the domain name registrar server 106 to communicate with the voice confirmation server 118 for providing the voice confirmation user interface 110, 112 to the user systems 102, 104. The voice confirmation API 116 allows for the domain name registrar server 106 to utilize the voice confirmation services of the voice confirmation server 108

In another embodiment, the voice confirmation user interface 110, 112 redirects a user system 110, 112 to the voice confirmation system 120 where the user is presented with the voice confirmation user interface 114. It should be noted that the redirecting process is performed in a seamless manner. In other words, the voice confirmation user interface 114 can resemble an interface on the domain name registrar server 106.

In one embodiment, when a user requests a domain name transaction such as a transfer of ownership or other records changes, the voice confirmation user interface 114 prompts the user for a telephone number. In another embodiment, the domain name registrar server 106 can pre-collect a phone number associated with the user. For example, a phone number included in the registration information of the domain name can be used. Once the telephone number is entered a unique identification pin is displayed to the user.

In one embodiment, either the domain name registrar server 106 or the voice confirmation server 118 can generate the unique identification pin. In the example above where the domain name registrar server 106 presents the voice confirmation user interface 114, the domain name registrar server 106 receives the telephone number input from the user. This information along with the generated unique identification pin is then relayed to the voice confirmation server 118. In the example where the user system 102, 104 is redirected to the voice confirmation server 108, the voice confirmation server 118 receives the telephone number input from the user.

The voice confirmation server 118 places an automated call to the user's communication device 120, 122 using the telephone number inputted by the user. The communication device 120, 122 can be any communication device capable of transmitting audio such as a telephone, cellular phone, smart phone, and the like. When the voice confirmation server 118 detects that the call has been terminated (picked up) by the communication device 120, 122 the use is prompted to either type in or speak the unique identification pin displayed to the user through the voice confirmation user interface. The voice confirmation server 118 records the user's typed or spoken entry and determines if the input received from the user matches the unique identification pin associated with the telephone number.

If the user input matches the generated unique identification pin, the user is then prompted to say his/her name. The voice confirmation server 118 records the user's spoken name. It should be noted that the present invention is not limited to the above sequence of events associated with the information provided by a user during the call. For example, the user can be prompted to speak his/her name first and then enter the generated unique identifier pin. In another embodiment, a terminating key on communication device being used by the user can be pressed after each prompt given by the voice confirmation server 118 to advance to the next prompt.

In one embodiment, the voice confirmation server 118, based on the input entered by the user, either passes or fails the authentication process. It should be noted that the voice confirmation server 118 can base its decision on only the unique identification pin entered, by the user, the spoken name of the user, or a combination of both. The recorded name of the user can be used by the voice confirmation server 118 to match against a previously recorded name of the user. For example, during the registration process of the domain name, the voice confirmation system of the present invention can be used in a similar manner as described above to capture a recording of the user's name. Therefore, when the user requests a record change for the domain name, the voice confirmation server 118 can compare the name recorded during the record change request to the previously recorded name at registration. If the names match and are spoken by the same person, the voice confirmation server 118 can determine that the user is the authenticate owner of the domain name. In one embodiment, the voice confirmation server 118 uses voice analysis software to compare audio recordings. In another embodiment, the recorded name of a user during the record change process can be used as evidence that the user presented himself/herself as the owner of the domain name.

If the user enters the incorrect unique identifier pin, refuses say his/her name, or if the currently recorded name does not match a previously recorded name, the voice confirmation server 118 can fail the authentication process for the user. The voice confirmation server 118 communicates the pass/fail information to the domain name registrar server 106. The domain name registrar server 106 can then decide whether to allow or not allow the requested record change.

One advantage of the present invention is that an added level of security is provided when registering a domain name or requesting a record change for a domain name. For example, instead of or in addition to verifying a user's identity by email, a user is called by the voice confirmation server 118 at a telephone number associated with the user. The user is required to enter a pin generated during the domain name transaction and speak his/her name. These two inputs are used as further authentication of the user, which provides a greater level of security.

Voice Confirmation Server

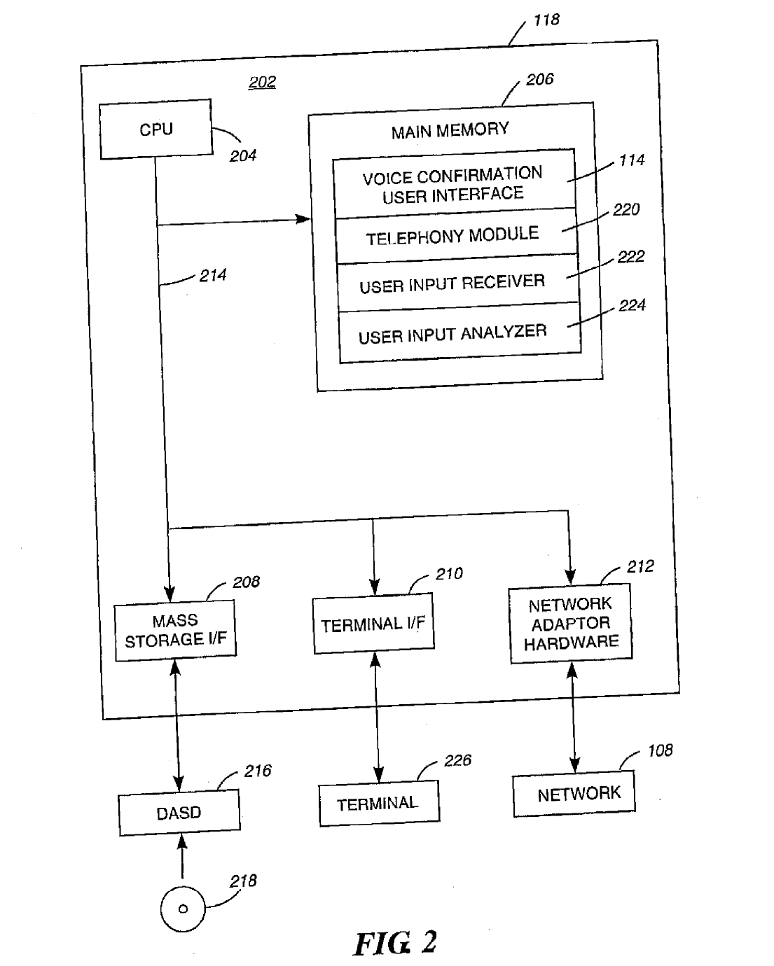

FIG. 2 is a block diagram illustrating a more detailed view of the voice confirmation server 118 according to an embodiment of the present invention. The voice confirmation server 118 is based upon a suitably configured information processing system adapted to implement the exemplary embodiment of the present invention. Any suitably configured information processing system is similarly able to be used as the voice confirmation server 118 by embodiments of the present invention, for example, a personal computer, workstation, or the like.

The voice confirmation server 118 includes a computer 202. The computer 202 has a processor 204 that is connected to a main memory 206, a mass storage interface 208, a terminal interface 210, and network adapter hardware 212. A system bus 214 interconnects these system components. Mass storage interface 208 is used to connect mass storage devices, such as a data storage device 216, to the voice confirmation server 118. One specific type of data storage device is a CD drive, which may be used to store data to and read data from a CD-ROM 218. Another type of data storage device is a data storage device configured to support NTFS type file system operations.

In one embodiment, the main memory 206 comprises the voice confirmation user interface 114, a telephony module 220, a user input receiver 222, and a user input analyzer 224. The voice confirmation user interface 114, as discussed above, can be presented to a user through a user interface 114 via the voice confirmation server 118 or by the voice confirmation server. The voice confirmation user interface 114 allows a user to input authentication information such as a telephone number and also displays a unique identifier pin. In one embodiment, the voice confirmation user interface 114 can display the results of the authentication process. However, in another embodiment, the results are not shown to the user.

The telephony module 220, in one embodiment, establishes a communication link with a communication device 120, 122 associated with the user. For example, based on the user authentication information (e.g., a telephone number) received from the voice confirmation server 118, the telephony module 220 places a call to the communication device 120, 122 associated with the use authentication information. The telephony module 220, in one embodiment, also controls the prompts given to the user during the call. For example, prompts for entering the unique identification pin and speaking the user's name are controlled by the telephony module 220.

The user input receiver 222, in one embodiment, receives input entered by the user during the authentication call. For example, the user input receiver 222 records the pin entered by the user and an audio clip of the user's name. This information can be stored locally in the main memory or can be stored in a remote database. The user input analyzer 224 analyzes the received user input to determine if the user is authenticate or not. For example, the user input analyzer compares the pin entered by the user during the call to the pin generated, in one embodiment, by the domain name registrar server 118. The user input analyzer 224, in one embodiment, also compares recorded audio clip of the user's name to a previously recorded audio clip of the user's name. For example, an audio clip of the user's name can be recorded during the domain name registration process. If each of these inputs matches their respective counterparts the voice confirmation server 118 can authenticate the user. The authentication results are then communicated to the voice confirmation server 118 so that it can determine whether to allow the user's record change request.

Although illustrated as concurrently resident in the main memory 206, it is clear that respective components of the main memory 206 are not required to be completely resident in the main memory 206 at all times or even at the same time. In one embodiment, the voice confirmation server 118 utilizes conventional virtual addressing mechanisms to allow programs to behave as if they have access to a large, single storage entity, referred to herein as a computer system memory, instead of access to multiple, smaller storage entities such as the main memory 206 and data storage device 216. Note that the term “computer system memory” is used herein to generically refer to the entire virtual memory of the voice confirmation server 118.

Although only one CPU 204 is illustrated for the computer 202, computer systems with multiple CPUs can be used equally effectively. Embodiments of the present invention further incorporate interfaces that each includes separate, fully programmed microprocessors that are used to off-load processing from the CPU 204. Terminal interface 210, according to one embodiment, is used to directly connect one or more terminals 226 to computer 202 to provide a user interface to the voice confirmation server 118. These terminals 226, which are able to be non-intelligent or fully programmable workstations, are used to allow system administrators and users to communicate with the voice confirmation server 118, The terminal 226 is also able to consist of user interface and peripheral devices that are connected to computer 202 and controlled by terminal interface hardware included in the terminal I/F 210 that includes video adapters and interfaces for keyboards, pointing devices, mp3 players, PDA docking stations, and the like.

An operating system (not shown) is also included in the main memory 206 and is a suitable multitasking operating system such as the Windows XP or Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the voice confirmation server 118 or in an alternative embodiment, the user systems 102, 104.

The network adapter hardware 212 is used to provide an interface to the network 108. Embodiments of the present invention are able to be adapted to work with any data communications connections including present day analog and/or digital techniques and/or via any networking mechanism such as wired, wireless, local area, and wide area networks, and any other types of networks and communications links as should be obvious to those of ordinary skill in the art in view of the present discussion.

Although the exemplary embodiments of the present invention are described in the context of a fully functional computer system, those skilled in the art will appreciate that embodiments are capable of being distributed as a program product via floppy disk, e.g. CD ROM 218, floppy disk (not shown), or other form of recordable media, or via any type of electronic transmission mechanism.

Domain Name Registrar Server

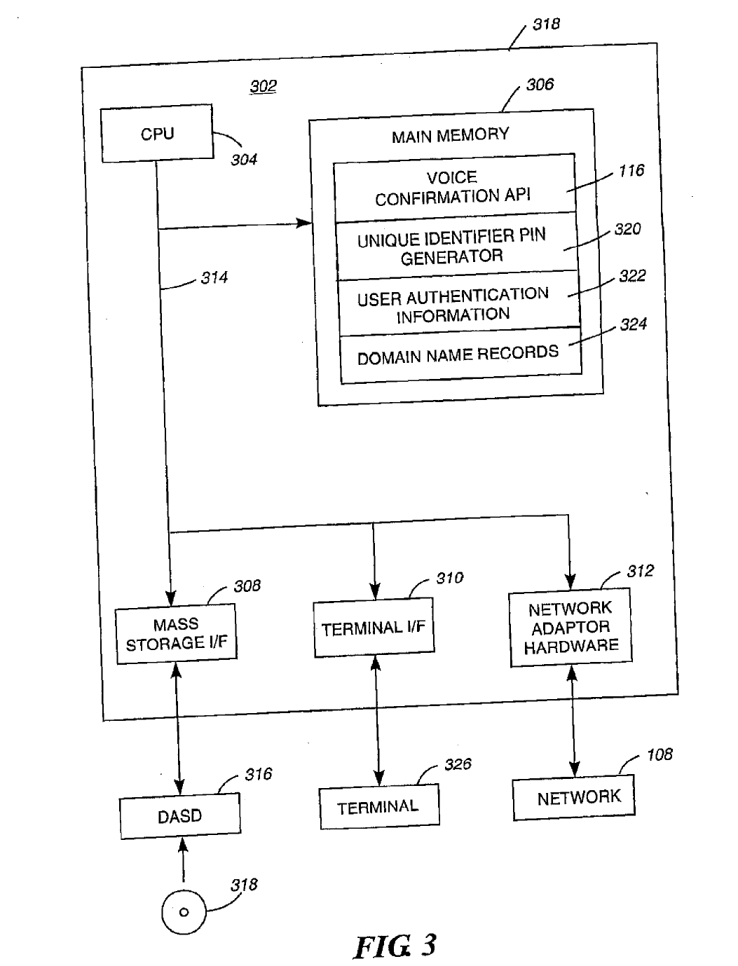

FIG. 3 is a block diagram illustrating a more detailed view of the domain name registrar server 106 according to an embodiment of the present invention. The domain name registrar server 106 is based upon a suitably configured information processing system adapted to implement the exemplary embodiment of the present invention. Any suitably configured information processing system is similarly able to be used as the domain name registrar server 106 by embodiments of the present invention, for example, a personal computer, workstation, or the like.

The domain name registrar server 106 includes a computer 302. The computer 302 has a processor 304 that is connected to a main memory 306, a mass storage interface 308, a terminal interface 310, and network adapter hardware 312. A system bus 314 interconnects these system components. Mass storage interface 308 is used to connect mass storage devices, such as a data storage device 316, to the domain name registrar server 106. One specific type of data storage device is a CD drive, which may be used to store data to and read data from a CD-ROM s18. Another type of data storage device is a data storage device configured to support NTFS type file system operations.

In one embodiment, the main memory 206 comprises the voice confirmation API 116, a unique identification pin generator 220, a user authentication information collector 222, and domain name records 224. The voice confirmation API 116 interfaces with the voice confirmation server 118. For example, the voice confirmation API 116 enables the domain name registrar server 106 to provide the voice confirmation user interface 114 to a user. The domain name registrar server 106 can integrate the voice confirmation services via XML. However, the integration interface is not limited to XML. As discussed above, a user interacts with the domain name registrar server 106 via a domain name registrar server user interface (not shown). In the embodiment where there domain name registrar server 106 provides the voice confirmation user interface 114 to the user, the voice confirmation user interface 114 appears to the user as part of the domain name registrar server user interface (not shown). However, in another embodiment, the domain name registrar server 106 can also redirect the user system 102, 104 to the voice confirmation server 118, where the voice confirmation user interface 114 is then provided to the user system 102, 104.

The unique identification pin generator 320, in one embodiment, identifies a unique pin that is used by the voice confirmation server 118 to authenticate a user. Once the unique identification pin is generated it is displayed to the user. The user authentication information collector 322, in one embodiment, collects user authentication information such as a telephone number associated with the user. In one embodiment, the user manually enters the telephone number into the voice confirmation user interface 114. The user authentication information collector 322 the records the entered telephone number.

In another embodiment, the user authentication information collector 322 retrieves a telephone number from the registrant information located in the domain name records 324 associated with the domain name. In another embodiment, if an audio clip has been recorded during the domain name registration process with the user's name, this audio clip is also retrieved by the user authentication information collector 322. In another embodiment, the voice confirmation server 118 can retrieve the audio clip on its own. Once the user authentication information is collected, it is communicated to the voice confirmation server 118 for authentication of the user. Once the domain name registrar server 106 receives the authentication results from the voice confirmation sever 118, the domain name registrar server 106 can decide whether to allow the user's request for a record change or to deny the request.

Although illustrated as concurrently resident in the main memory 306, it is clear that respective components of the main memory 306 are not required to be completely resident in the main memory 306 at all times or even at the same time. In one embodiment, the domain name registrar server 106 utilizes conventional virtual addressing mechanisms to allow programs to behave as if they have access to a large, single storage entity, referred to herein as a computer system memory, instead of access to multiple, smaller storage entities such as the main memory 306 and data storage device 316. Note that the term “computer system memory” is used herein to generically refer to the entire virtual memory of the voice confirmation server 118.

Although only one CPU 304 is illustrated for the computer 302, computer systems with multiple CPUs can be used equally effectively. Embodiments of the present invention further incorporate interfaces that each includes separate, fully programmed microprocessors that are used to off-load processing from the CPU 304. Terminal interface 310, according to one embodiment, is used to directly connect one or more terminals 326 to computer 302 to provide a user interface to the voice confirmation server 118. These terminals 326, which are able to be non-intelligent or fully programmable workstations, are used to allow system administrators and users to communicate with the domain name registrar server 106. The terminal 326 is also able to consist of user interface and peripheral devices that are connected to computer 302 and controlled by terminal interface hardware included in the terminal I/F 310 that includes video adapters and interfaces for keyboards, pointing devices, mp3 players, PDA docking stations, and the like.

An operating system (not shown) is also included in the main memory 306 and is a suitable multitasking operating system such as the Windows XP or Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the domain name registrar server 106 or in an alternative embodiment, the user systems 102, 104.

The network adapter hardware 312 is used to provide an interface to the network 108. Embodiments of the present invention are able to be adapted to work with any data communications connections including present day analog and/or digital techniques and/or via any networking mechanism such as wired, wireless, local area, and wide area networks, and any other types of networks and communications links as should be obvious to those of ordinary skill in the art in view of the present discussion.

Although the exemplary embodiments of the present invention are described in the context of a fully functional computer system, those skilled in the art will appreciate that embodiments are capable of being distributed as a program product via floppy disk, e.g. CD ROM 318, floppy disk (not shown), or other form of recordable media, or via any type of electronic transmission mechanism.

Voice Confirmation User Interface

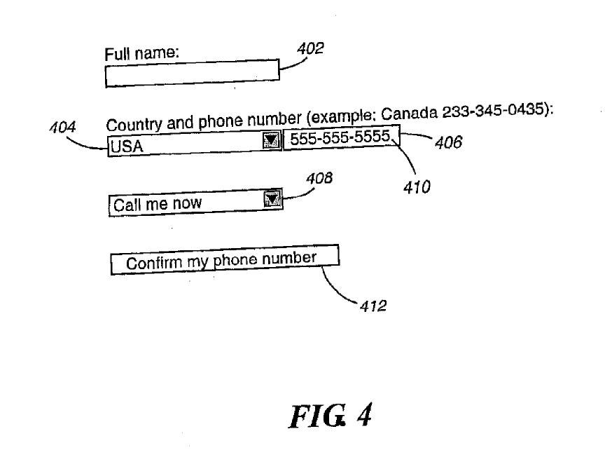

FIG. 4 shows a detailed view of the voice confirmation user interface 114 according to an embodiment of the present invention. It is noted that the voice confirmation user interface 114 illustrated in FIG. 4 is only an exemplary embodiment and may include or not include one or more additional components. The voice confirmation user interface 114 allows a user to enter and receiver user authentication information.

The voice confirmation user interface 114 includes various entry boxes 402, 404, 404, 408. A name entry box 402, in one embodiment, is provided for personalizing the authentication process to the user. A country selection box 404 and a telephone number entry box 406 are also included. The country selection box 404 allows a user to enter or select a country associated with the user's location. The country information is used by the voice confirmation server 118 to determine dialing rules for placing a call to the user. The voice confirmation server 118 places a call to the user at the telephone number 410 entered by the user in the telephone number entry box 406. In another embodiment, the telephone number is provided to the voice confirmation server 118 by the domain name registrar server 106. The user, in one embodiment, can also select or enter a time in a time entry box 408 for the voice confirmation server 118 to call the user. A clickable widget 412 is also included in one embodiment so that the user can initiate the voice confirmation process. It should be noted that the components of the voice confirmation user interface 114 discussed above are only exemplary and do not limit the present invention in any way.

Exemplary Process of Interacting with a Voice Confirmation Server for User Authentication

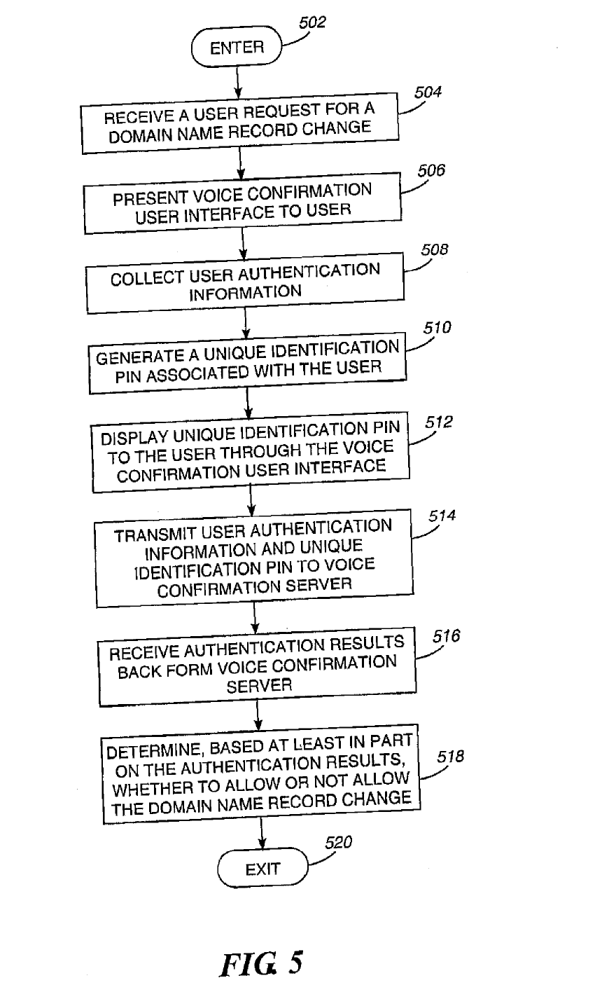

FIG. 5 is an operational flow diagram illustrating an exemplary process of the domain name registrar server 106 interacting with the voice confirmation server 118 for authenticating a user. The operational flow diagram of FIG. 5 begins with step 502 and flows directly to step 504. The domain name registrar server 106, at step 504, receives a user request for a domain name record change. For example, a user may want to change the registrant information or transfer ownership of the domain name. The domain name registrar server 106, at step 506, presents the voice confirmation user interface 114. As discussed above, the voice confirmation user interface 114 the domain name registrar server 106 can directly provide the voice confirmation user interface 114 or can redirect the user to the voice confirmation server 118, which can then provide the voice confirmation user information to the user.

The domain name registrar server 106, at step 508, collects user authentication information such as a telephone number. The user authentication information can be entered manually by the user or the domain name registrar server 106 can automatically collect the information. For example, the domain name registrar server 106 can retrieve the user authentication information from the domain name records 324. The domain name registrar server 106, at step 510, generates a unique identification pin and displays this pin to the user at step 512. The user authentication information and the generated pin, at step 514, are transmitted to the voice confirmation system. The domain name registrar server 106, at step 516, then receives authentication results back from the voice confirmation server 118. Based upon the authentication results, the domain name registrar server 106, at step 518, decides whether to allow or not allow the user's record change request. The control flow then exits at step 520.

Exemplary Process of Authenticating a User Via Voice Confirmation

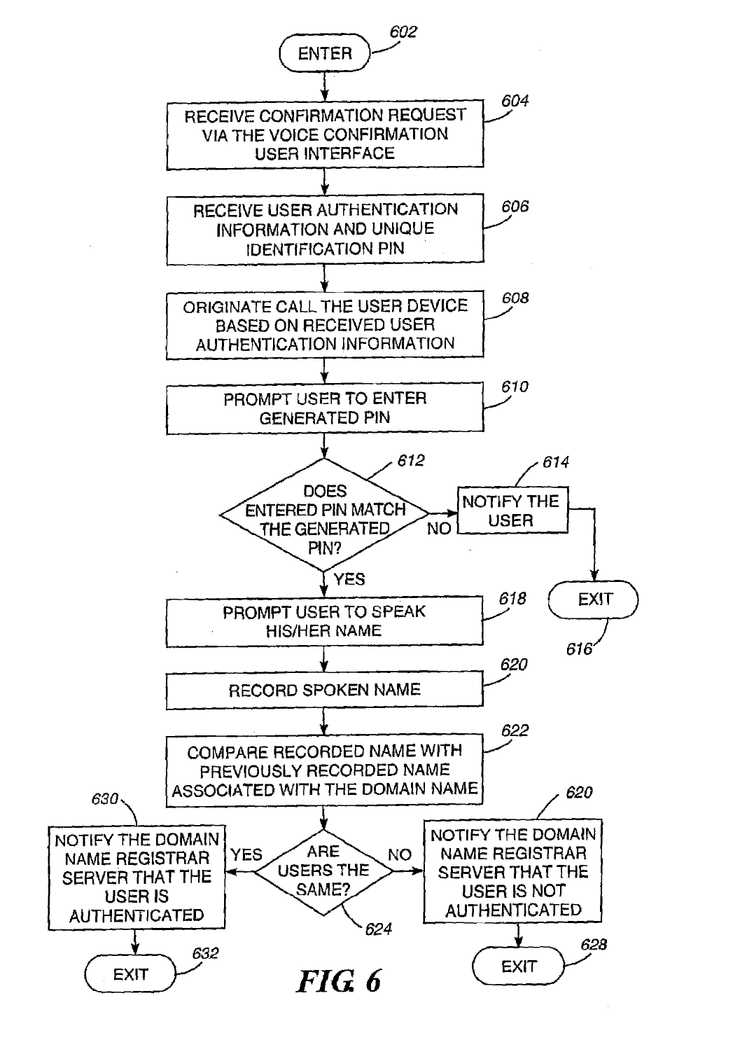

FIG. 6 is an operational flow diagram illustrating an exemplary process of authentication a user via the voice confirmation server 118. The operational flow diagram of FIG. 6 begins with step 602 and flows directly to step 604. The voice confirmation server 118, at step 604, receives a confirmation request via the voice confirmation user interface 114. User authentication information and a generated unique identifier pin, at step 606, are received by the voice confirmation server 106. The voice confirmation server 106, at step 608, originates a call to the user based on the user authentication information The user, at step 610, is prompted to enter the generated unique identifier pin.

The voice confirmation server 106, at step 612, determines if the pin entered by the user matches the generated unique identifier pin. If the result of this determination is negative, the user, at step 614, is notified and the control flow exits at step 616. In another embodiment, the user can be given one or more chances to re-enter the correct pin. If the result of this determination is positive, according to the present example, the user, at step 618, is prompted to speak his/her name. It should be noted that this is only one example, and that any phrase or utterance could be spoken by a user or any other sound or combination of sounds could be provided by a user according to alternative embodiments of the present invention. Continuing with the present example, the voice confirmation server 106, at step 620, records the user's name. The voice confirmation server 106, at step 622, compares the recorded name to a previously recorded audio clip of the user's name. The voice confirmation server 106, at step 624, determines whether the same individual who spoke the user's name in the previous recording matches is the individual who spoke the user's name in the current recording.

If the result of this determination is negative, the domain name registrar server 106, at step 626, is notified that the user is not authenticated. The control flow exits at step 628. If the result of this determination is positive, the domain name registrar 106, at step 630, is notified that the user has been authenticated. The control flow then exits at step 632.

Non-Liming Examples

The present invention can be realized in hardware, software, or a combination of hardware and software. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of computer readable media. Illustrative computer readable medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system, for managing a user transaction request associated with a domain name based on an authentication status of the user, the method comprising:
receiving a request from a user for a transaction associated with a domain name presenting a voice confirmation user interface to the user;
collecting user authentication information, comprising spoken user authentication information, from the user;
communicating the user authentication information to an information processing system;
receiving an authentication status associated with the user from the information processing system; and
determining to allow the request from the user for the transaction associated with the domain name based at least in part on the received authentication status.

2. The method of claim 1, wherein the transaction associated with the domain name is at least one of:
transferring ownership of the domain name;
updating registrant information associated with the domain name; and
updating billing information associated with the domain name.

3. The method of claim 1, wherein the presenting a voice confirmation user interface to the user further comprises:
redirecting a user interface to a voice confirmation server, wherein the voice confirmation server presents the voice confirmation user interface to the user.

4. The method of claim 1, wherein the presenting a voice confirmation user interface to the user further comprises:
communicating with a voice confirmation server comprising the voice confirmation user interface via an XML interface; and
presenting the voice confirmation user interface to the user through the XML interface.

5. The method of claim 1, wherein the collecting user authentication information further comprises one of:
prompting the user to enter a telephone number associated with the user; and
determining a telephone number associated with the user based on registration information for the domain name.

6. A method, with an information processing system, for authenticating a domain name registrant, the method comprising:
receiving a request for authenticating a user requesting a transaction associated with a domain name;
establishing an audible communication link with a communication device associated with the user;
prompting the user to enter user authentication information;
receiving spoken user authentication information from the user;
analyzing the spoken user authentication information received from the user; and
determining the authenticity of the user based on the analyzing of the user authentication information.

7. The method of claim 6, wherein the establishing the audible communication link further comprises:
placing a telephone call to the communication device associated with the user.

8. The method of claim 6, wherein the prompting further comprises:
prompting the user to enter a user authentication code.

9. The method of claim 6, wherein the prompting further comprises:
prompting the user to speak the user's name; and
recording the user's name.

10. The method of claim 6, wherein the analyzing further comprises:
comparing the user authentication information to previously stored user authentication information.

11. The method of claim 10, wherein the determining the authenticity comprises:
determining, based on the comparing, if the user authentication information matches the previously stored user authentication information; and
authenticating, in response to the user authentication information matching the previously stored user authentication information, the user.

12. The method of claim 10, wherein the user authentication information is an audio file comprising the user's name and the previously stored user authentication information is a previously recorded audio file comprising the user's name.

13. An information processing system for authenticating a domain name registrant, the information processing system comprising:
a memory;
a processor communicatively coupled to the memory;
an authentication request receiver, wherein the authentication request receiver receives a request for authenticating a user requesting a transaction associated with a domain name;
a telephony module, wherein the telephony module establishes audible communication link with a communication device associated with the user;
a voice confirmation module, wherein the voice confirmation module prompts the user to enter user authentication information over the audible communication link, the voice confirmation module receiving spoken user authentication information from the user.
an authentication information analyzer, wherein the authentication information analyzer analyzes the spoken user authentication information received from the user; and
a user authenticator, wherein the user authenticator determines the authenticity of the user based on the analyzing of the user authentication information.

14. The information processing system of claim 13, wherein the telephony module places a telephone call to the communication device associated with the user.

15. The information processing system of claim 13, wherein the prompting by the voice confirmation server further comprises at least one of prompting the user to enter a user authentication code and prompting the user to speak the user's name, wherein the user's name is recorded and stored in the memory.

16. The information processing system of claim 13, wherein the authentication information analyzer further compares the user authentication information to previously stored user authentication information.

17. The information processing system of claim 13, wherein the user authenticator further determines, based on the comparing, if the user authentication information matches the previously stored user authentication information, and authenticates, in response to the user authentication information matching the previously stored user authentication information, the user.

18. The information processing system of claim 17, wherein the user authentication information comprises an audio file including the user's name and the previously stored user authentication information in a previously recorded audio file comprising the user's name.

19. An information processing system for managing a user transaction request associated with a domain name based on an authentication status of the user, the information processing system comprising:
a memory;
a processor communicatively coupled to the memory;
a user request receiver, wherein the user request receiver receives a request from a user for a transaction associated with a domain name;
a voice conformation user interface, wherein the voice confirmation user interface is presented to the user for collecting user authentication information, comprising spoken user authentication information, from the user;
a transmitter, wherein the transmitter communicates the user authentication information to an information processing system;
a user authentication receiver, wherein the user authentication receiver receives an authentication status associated with the user from the information processing system, wherein the request from the user for the transaction associated with the domain name is allowed based at least in part on the received authentication status.

20. The information processing system of claim 19, wherein the voice confirmation user interface is presented to the user by redirecting a user interface to a voice confirmation server, wherein the voice confirmation server presents the voice confirmation user interface to the user.

21. The information processing system of claim 19, wherein the voice confirmation user interface is presented to the user by communicating with a voice confirmation server comprising the voice confirmation user interface via an XML interface and presenting the voice confirmation user interface to the user through the XML interface.

22. The information processing system of claim 19, wherein the user authentication information is collected by prompting the user to enter a telephone number associated with the user, and determining a telephone number associated with the user based on registration information for the domain name.
